(19) United States
(12) Patent Application Publication
(10) Pub. No.: US 2012/0148737 A1
(43) Pub. Date: Jun. 14, 2012

(54) PROCESS FOR PRODUCING LAMINATED OPTICAL FILM

(75) Inventors: Makoto Komatsubara, Ibaraki-shi (JP); Tomoaki Masuda, Ibaraki-shi (JP)

(73) Assignee: NITTO DENKO CORPORATION, Ibaraki-shi, Osaka (JP)

(21) Appl. No.: 13/384,696

(22) PCT Filed: Jul. 12, 2010
(86) PCT No.: PCT/JP10/61771

§ 371 Date: Jan. 18, 2012

(30) Foreign Application Priority Data
Jul. 27, 2009 (JP) 2009-174235

(51) Int. Cl. B05D 5/06

(52) U.S. Cl. 427/162

(57) ABSTRACT

An object of the invention is to provide a process for continuously producing a laminated optical film, the process being able to produce a laminated optical film in which the occurrence of a point defect is suppressed. Provided is a process for producing a laminated optical film, including: a rubbing treatment step of subjecting a surface of a continuous base film to a rubbing treatment to form a rubbing treated surface while the film is transported in a longitudinal direction; a bending transport step of bending and transporting the film subjected to the rubbing treatment step using a plurality of guides for bending the transport direction; and a coating step of coating the rubbing treated surface of the film subjected to the bending transport step with a solution containing a lyotropic liquid crystal compound to form an optically anisotropic film, wherein in the bending transport step, a guide having a gas-jetting device is used as a guide provided on the rubbing treated surface side to bend the transport direction of the film without contacting the rubbing treated surface with the guide.

### FIELD OF THE INVENTION

The present invention relates to a process for producing a laminated optical film.

### RELATED ART

As a process for producing a laminated optical film, for example, a process in which a surface of a continuous base film is subjected to a rubbing treatment where it is rubbed unidirectionally with a brushed cloth, etc. to form a rubbing treated surface, and the rubbing treated surface is coated with an aqueous solution containing a lyotropic liquid crystal compound to form an optically anisotropic film has been heretofore known (Patent Document 1).

In this production process, it is conceivable to continuously produce a laminated optical film in order to enhance the production efficiency.

More particularly, it is conceivable to perform a rubbing treatment step of subjecting a surface of a continuous base film to a rubbing treatment to form a rubbing treated surface while the film is transported in a longitudinal direction; a bending transport step of bending and transporting the film subjected to the rubbing treatment step using a plurality of guide rolls for bending the transport direction in order to transport the film stably; and a coating step of coating the rubbing treated surface of the film subjected to the bending transport step with a solution containing a lyotropic liquid crystal compound to form an optically anisotropic film, to continuously produce a laminated optical film.

A problem of such a process for producing a laminated optical film is, however, that a point defect appears in a produced laminated optical film.

### PRIOR ART DOCUMENTS

### Patent Documents

Patent Document 1: Japanese Patent Application Laid-Open No, 2002-311246

### DISCLOSURE OF THE INVENTION

### Problems to be Solved by the Invention

The present invention has been made in view of the aforedescribed problem of the conventional art and an object thereof is to provide a process for continuously producing a laminated optical film, the process being able to produce a laminated optical film in which the occurrence of a point defect is suppressed.

### Means for Solving Problems

Although the cause of the occurrence of a point defect in a laminated optical film has not been clarified obviously, the present inventors intensively have studied to attain the object, found that, when a guide having a gas-jetting device is used as a guide provided on the rubbing treated surface side to bend the film transport direction without contacting the rubbing treated surface with the guide and produce a laminated optical film, the occurrence of a point defect in a produced laminated optical film is suppressed, and completed the present invention.

According to the present invention, there is provided a process for producing a laminated optical film, which includes: a rubbing treatment step of subjecting a surface of a continuous base film to a rubbing treatment to form a rubbing treated surface while the film is transported in a longitudinal direction; a bending transport step of bending and transporting the film subjected to the rubbing treatment step using a plurality of guides for bending the transport direction; and a coating step of coating the rubbing treated surface of the film subjected to the bending transport step with a solution containing a lyotropic liquid crystal compound to form an optically anisotropic film,

wherein in the bending transport step, a guide having a gas-jetting device is used as a guide provided on the rubbing treated surface side to bend the transport direction of the film without contacting the rubbing treated surface with the guide.

According to such a process for producing a laminated optical film, since in the bending transport step, a guide having a gas-jetting device is used as a guide provided on the rubbing treated surface side to bend the film transport direction without contacting the rubbing treated surface with the guide, the contact of the rubbing treated surface with the guide can be prevented while the film is transported continuously. Then in the coating step, since the rubbing treated surface not influenced by the contact with the guide is coated with a solution containing a lyotropic liquid crystal compound, the lyotropic liquid crystal compound can be relatively uniformly oriented on the rubbing treated surface. Consequently, the orientation of a lyotropic liquid crystal compound in a formed optically anisotropic film is relatively uniform and the occurrence of a point defect in a laminated optical film can be suppressed.

Herein the term “optical film” means a light transmissive film having an optical function. Specific examples of the optical function include refraction and double refraction.

### Advantages of the Invention

As described above, according to the present invention, a laminated optical film in which the occurrence of a point defect is suppressed can be produced continuously.

### BRIEF DESCRIPTION OF DRAWINGS

FIG. 1 is a schematic diagram of an apparatus used in a process for producing a laminated optical film according to the present embodiment.

FIG. 2 is a schematic diagram of an apparatus used in a conventional process for producing a laminated optical film.

FIG. 3 is a schematic diagram showing a guide having a gas-jetting device.

FIG. 4 is a schematic diagram of a laminated optical film.

FIG. 5 is a picture from observation of a point defect in a laminated optical film in an Example.

FIG. 6 is a picture from observation of a point defect in a laminated optical film in a Comparative Example.

### DESCRIPTION OF EMBODIMENT

An embodiment of a process for producing a laminated optical film according to the present invention will be described below with reference to the attached drawings.

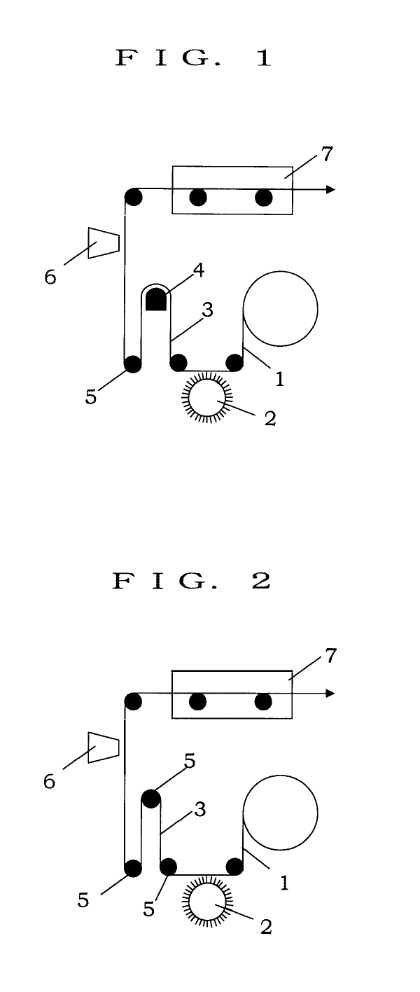

A process for producing a laminated optical film according to the present embodiment is, as shown in FIG. 1, a process for continuously producing a laminated optical film, including a rubbing treatment step of subjecting a surface of a continuous base film to a rubbing treatment to form a rubbing treated surface while the film is transported in a longitudinal direction; a bending transport step of bending and transporting the film subjected to the rubbing treatment step using a plurality of guides for bending the transport direction; and a coating step of coating the rubbing treated surface of the film subjected to the bending transport step with a solution containing a lyotropic liquid crystal compound to form an optically anisotropic film,

wherein in the bending transport step, a guide having a gas-jetting device is used as a guide provided on the rubbing treated surface side to bend the transport direction of the film without contacting the rubbing treated surface with the guide.

In the rubbing treatment step, as shown in FIG. 1, a continuous base film 1 is transported in a longitudinal direction and simultaneously a surface of the continuous base film is subjected to a rubbing treatment in which the surface is rubbed unidirectionally with a rubbing roll 2 to form a rubbing treated surface.

Here, the film can be transported continuously along a longitudinal direction, for example by feeding out the wound-up continuous base film 1 downstream, drawing the film toward the downmost stream side, or rotating the guide rolls 5 contacting the film to send the film downstream.

The term “continuous” for a continuous base film 1 means that the length in the longitudinal direction is sufficiently longer than the length in the width direction (e.g., 10 times or more).

The rubbing treatment is a treatment in which a rubbing treated surface is formed by unidirectionally rubbing a surface of a continuous base film 1. By performing a rubbing treatment, the rubbing treated surface acquires orientation, and a lyotropic liquid crystal compound in a solution applied in a coating step performed thereafter is presumably oriented on the rubbing treated surface.

As a rubbing roll 2 to be used in the rubbing treatment, for example a rotatable roller carrying a wound-up cloth on a surface can be used. More particularly, for example, a rotatable metal roller on a surface of which a buffing cloth (fiber cloth with a pile length of several millimeters) is wound up and fixed by an adhesive, etc., can be used.

Although there is no particular restriction on the revolution speed of the rubbing roll 2, 100 rpm to 2,000 rpm is preferable from the viewpoint of possibly more uniform orientation of a lyotropic liquid crystal compound.

Further, although there is no particular restriction on the number of rubbing repetitions in the rubbing treatment, 1 to 3 times are preferable from the viewpoint of possibly more uniform orientation of a lyotropic liquid crystal compound. Here, the number of rubbing repetitions can be increased by increasing the number of rubbing rolls 2. More particularly, for a number of rubbing repetitions of 2, 2 rubbing rolls 2 are used.

Although there is no particular restriction on the length of the continuous base film 1 in the longitudinal direction, it is usually 300 m or longer. Further, although there is no particular restriction on the width of the continuous base film 1 (the length orthogonal to the longitudinal direction), it is usually 100 to 2,000 mm. Further, although there is no particular restriction on the thickness of the continuous base film 1, it is preferably 5 μm to 200 μm.

The continuous base film 1 may be a monolayer film, or a multilayer film in which a plurality of films composed of the same or different materials are laminated.

There is no particular restriction on a material composing the continuous base film 1, and usable examples thereof include a polyester resin, a cellulosic resin, a cycloolefin resin, an acrylic resin, a polyimide resin, and polyvinyl alcohol.

A rubbing treated surface formed by a rubbing treatment of the continuous base film 1 usually has grooves, namely an asperity shape, along the rubbing direction.

In the bending transport step, a film is passed through a transport stabilizing mechanism so that the film is transported stably. The transport stabilizing mechanism is provided with a plurality of guides for bending the film transport direction, and these guides are located at pre-determined intervals in the longitudinal direction of the film so that the film travels in a zigzag (so that the film is alternately bent to a reverse direction). They are configured so that, by adjusting the interval between a guide located on a surface side of the film and the next guide located downstream of the transport direction on the other surface side of the film, the traveling film is tensed and transported stably. In other words, they are configured so that, by adjusting the length from a bend of the film to the next bend whose bending direction is opposite to the bending direction of the former bend, the traveling film is tensed and transported stably.

Moreover, in the bending transport step, as a guide located on the rubbing treated surface side, a guide 4 having a gas-jetting device is used to bend the film transport direction without contacting the rubbing treated surface with the guide 4.

In the bending transport step, as guides, a guide roll 5, which is located on the opposite side of the surface on which a rubbing treated surface is formed and can bend the film transport direction by rotating in contact with the film, and a guide 4 having a gas-jetting device, which is located on the rubbing treated surface side of the film 3 on which the rubbing treated surface is formed and can bend the film transport direction without contacting the rubbing treated surface are used.

In other words, in the bending transport step, as guides, not only guide rolls 5 are used as in a conventional process for producing a laminated optical film illustrated in FIG. 2, but also a guide 4 having a gas-jetting device located on the rubbing treated surface side is used.

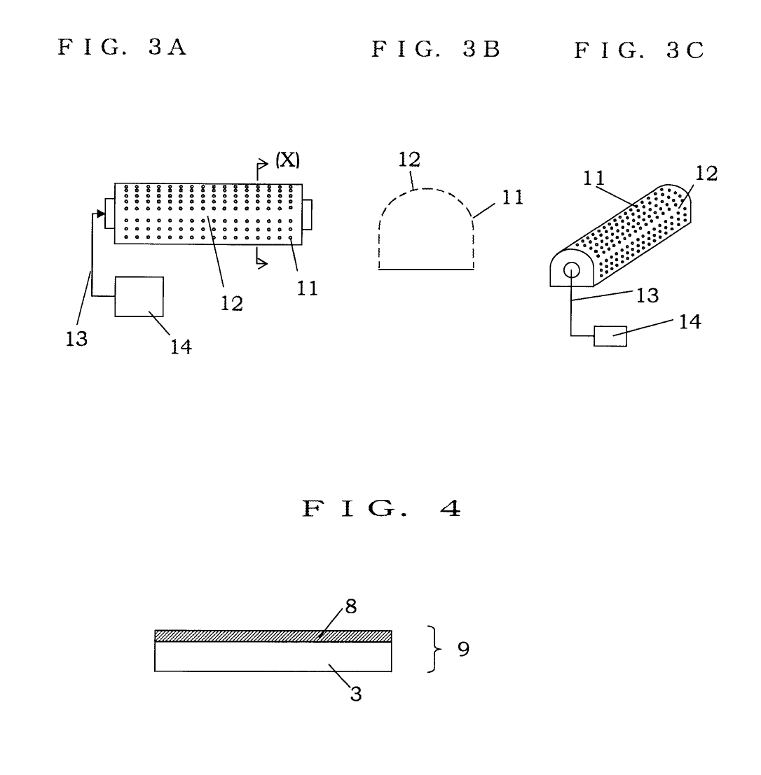

The guide 4 having a gas-jetting device will be described in detail with reference to a drawing (FIG. 3) illustrating an example of a preferable embodiment of the guide 4.

FIG. 3(a) is a schematic diagram of a guide 4 having a gas-jetting device observed from the side and FIG. 3(b) is a cross-sectional view of the guide 4 having a gas-jetting device taken along the line X in FIG. 3(a). FIG. 3(c) is a perspective view of the guide.

In order to bend the film transport direction without contacting a rubbing treated surface with the guide 4 having a gas-jetting device, the guide is provided, as shown in FIG. 3, with a guide surface 12 having gas-jetting holes 11 formed thereon, as a gas-jetting device, which plays the role of bending the film transport direction, a gas feed line 13 for supplying a gas to the gas-jetting holes 11, and a blower 14 connected to the gas feed line 13. On the guide surface 12, a plurality of gas-jetting holes 11 are formed to jet a gas outward.

As the gas feed line 13 and the blower 14, heretofore known general types can be used.

The guide surface 12 of the guide 4 having the gas-jetting device is formed so that its longitudinal direction is congruent with the width direction of the film. In addition, the guide surface 12 has the shape of a rectangle a side of which is a convex arc in a cross section orthogonal to the longitudinal direction as shown in FIG. 3(b).

With the guide 4 having the gas-jetting device, as shown in FIG. 1, a film 3 on which a rubbing treated surface is formed can move while floating along the guide surface 12 by the pressure of a gas blown out of the gas-jetting holes 11. In other words, a film 3 on which a rubbing treated surface is formed can move while bending the transport direction without contacting the guide surface 12 along the guide surface 12.

Although there is no particular restriction on the type of a gas blown out of the guide 4 having the gas-jetting device, air or an inert gas is preferable.

For the guide 4 having the gas-jetting device, the gas flow rate through the gas feed line 13 is preferably set at 1 m³/min to 50 m³/min per 1 m of the width of the film 3 on which a rubbing treated surface is formed depending on the thickness or the width, and the elasticity of the film 3 on which a rubbing treated surface is formed. The size of the gas-jetting holes 11 is preferably set at 0.5 mm to 4 mm, and the intervals between the gas-jetting holes 11 are preferably set at 5 mm to 50 mm. Further the transport speed of the film 3 on which a rubbing treated surface is formed is set preferably at 1 m/min to 100 m/min.

By selecting the above preferable gas-jetting conditions and the preferable transport speed of the film, the guide 4 having a gas-jetting device can more securely bend the transport direction of the film without contacting the guide surface 12 and transport the same. The film floating height (the height from the guide surface 12) is preferably set at 0.5 mm or higher by selecting the preferable gas-jetting conditions and the preferable transport speed from the viewpoint of more securely changing the transport direction and transporting the film without contacting the guide surface.

In the coating step, a rubbing treated surface of a film subjected to the bending transport step (a film which a rubbing treated surface is formed on in the rubbing treatment step and passed through the bending transport step) is coated with a solution containing a lyotropic liquid crystal compound to form an optically anisotropic film.

The lyotropic liquid crystal compound means a liquid crystal compound which causes a phase transition from an isotropic phase to a liquid crystal phase by changing the concentration when dissolved in a solvent. The lyotropic liquid crystal compound can be unidirectionally oriented by coating a rubbing treated surface with a liquid containing the lyotropic liquid crystal compound in an isotropic phase state or a liquid crystal phase state. By the oriented lyotropic liquid crystal compound, an optically anisotropic film is formed.

The optically anisotropic film is an almost unidirectionally oriented lyotropic liquid crystal compound, and exhibits at least one optical anisotropy in refraction, absorption, scattering and reflection. If the optically anisotropic film exhibits, for example, absorption dichroism, the optically anisotropic film can function as a polarizing film.

Although there is no particular restriction on the thickness of the optically anisotropic film, it is preferably 0.1 μm to 5.0 μm.

There is no particular restriction on the lyotropic liquid crystal compound, insofar as it exhibits the aforedescribed properties, and usable examples of such a compound include azo compounds, anthraquinone compounds, perylene compounds, quinophthalone compounds, naphthoquinone compounds, and merocyanine compounds.

As the lyotropic liquid crystal compound, a compound synthesized by a heretofore known general method can be used. Further, a commercially available product can be used.

The solution used in the coating step (hereinafter also referred to as “coating solution”) contains a lyotropic liquid crystal compound and a solvent.

There is no particular restriction on the solvent contained in the solution (the coating solution), insofar as it brings a lyotropic liquid crystal compound to an isotropic phase state or a liquid crystal phase state, and usable examples of the solvent include water, alcohols, cellosolves, and a mixture solvent of two or more thereof.

The concentration of a lyotropic liquid crystal compound in the solution (the coating solution) is preferably 1% by weight to 15% by weight from the viewpoint of appropriate viscosity of the solution resulting in easy performance of the coating step.

The solution (the coating solution) may contain an additive. Usable examples of the additive include a surfactant, an antioxidant, and an orienting aid.

There is no particular restriction on a coating method for the solution (the coating solution) in the coating step, and, for example, a method using a coater 6 as shown in FIG. 1 may be employed.

Usable examples of the coater 6 include a coater having a tensioned web die, a slot die opposing a back-up roll, a wire bar, or a curtain roll.

In a drying step, an optically anisotropic film formed in the coating step can be dried. In other words, a solvent derived from the solution (the coating solution) coating the film in the coating step can be reduced.

An optically anisotropic film formed in the coating step is preferably dried in the drying step so that a solvent contained in the solution (the coating solution) is reduced to 50% by weight or less in the optically anisotropic film. As a drying method, natural drying, vacuum drying, drying by heating, etc. can be adopted, and drying by heating in a drying oven 7 as shown in FIG. 1 is preferably adopted from the viewpoint of its simplicity and relatively fast drying.

Here, the film is transported in the drying step usually by locating guide rolls 5 for transporting the film on the side opposite to the side on which an optically anisotropic film is formed, so as not to disturb the orientation of the optically anisotropic film formed.

A laminated optical film 9 produced by the production process has, as shown in FIG. 4, a film 3 on which a rubbing treated surface is formed, and an optically anisotropic film 8 laminated on a surface (the rubbing treated surface) of the film 3 on which a rubbing treated surface is formed. Although there is no particular restriction on the total thickness of the laminated optical film, 10 to 300 μm is preferable.

Examples of a favorable use of the laminated optical film 9 include a polarizing plate protection film, a phase difference film, and an optical compensation film, and especially the use as a polarizing plate protection film is favorable.

A process for producing a laminated optical film according to the present embodiment is as described above, provided that the present invention is not limited to the aforedescribed process for producing a laminated optical film. According to the present invention, various features adopted in general processes for producing a laminated optical film may be adopted to the extent that the advantageous effects of the present invention are not impaired.

In the process for producing a laminated optical film, for example, between the rubbing treatment step and the coating step, a corona treatment step of corona-treating a rubbing treated surface of a film 3 on which a rubbing treated surface is formed may be performed. Further, a plasma treatment step of plasma-treating a rubbing treated surface of a film 3 on which a rubbing treated surface is formed may be performed.

By performing the corona treatment step or the plasma treatment step, a rubbing treated surface can be made hydrophilic to improve the adherence between a film 3 on which a rubbing treated surface is formed and an optically anisotropic film 8.

### EXAMPLE

The present invention will be described in more detail below by means of an Example, provided that the present invention is not limited thereto.

### Example

### Synthesis of Lyotropic Liquid Crystal Compound

By diazotization and a coupling reaction of 4-nitroaniline and 8-amino-2-naphthalenesulfonic acid according to a conventional method (Yutaka Hosoda, “Riron Seizo Senryou-Kagaku” (5th edition), 15.7.1968, paragraph 135-152, Gihodo Shuppan Co., Ltd.), a monoazo compound was produced.

The monoazo compound was diazotized similarly according to a conventional method and further subjected to a coupling reaction with 1-amino-8-naphthol-2,4-disulfonate lithium salt to yield a crude product containing an azo compound according to the following structural formula (I), which was salted out by lithium chloride to obtain the azo compound according to the following structural formula (I).

The azo compound was dissolved in water and observed under a polarizing microscope to find that it exhibited a nematic liquid crystal phase at 20% by weight.

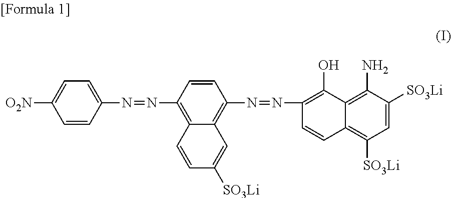

### Production of Laminated Optical Film

A laminated optical film was produced by installing the respective devices for producing a laminated optical film as shown in FIG. 1.

Namely, as a continuous base film, a wound-up continuous cycloolefin resin film (width, 400 mm; manufactured by Zeon Corporation; trade name, Zeonor) having a thickness of 40 μm was set and the film was transported continuously unidirectionally (transport speed 5 m/min).

While the film was being transported, a surface thereof was rubbed by a rubbing roll. More particularly, as a rubbing roll a rotational metal roller wound with a buffing cloth made of a conjugated fiber of polyester and nylon (manufactured by Kuraray Trading Co., Ltd.; trade name, Micro Fiber) was used. With this rubbing roll (revolving speed, 1,600 rpm; revolving direction, opposite to the film transport direction), a rubbing treatment step was performed to perform a rubbing treatment by rubbing the continuous base film unidirectionally.

Concurrently, a rubbing treated surface of the film provided with a rubbing treated surface was subjected to a corona treatment, and the film was stably transported using a plurality of guides while being bent. As a guide to be located on the rubbing treated surface side, a guide having a gas-jetting device as shown in FIG. 3 (size of gas-jetting holes=1 mm; interval=20 mm) was used to exercise continuously a bending transport step by changing the film transport direction, avoiding the contact of the rubbing treated surface with the guide by means of an air blow from the gas-jetting holes (air flow rate, 5 m³/min per 1 m of the film width) for floating the film 0.5 mm above the guide surface.

Concurrently, a coating step was performed continuously by uniformly coating the rubbing treated surface with an aqueous solution in which the concentration of the azo compound was prepared at 7% by weight, using a coater having a tensioned web die to form an optically anisotropic film.

Then, a drying step was performed using an oven thermoregulated at 40° C. to produce a laminated optical film having a 0.4 μm-thick optically anisotropic film on a film surface on which a rubbing treated surface was formed.

### Comparative Example

A laminated optical film was produced by a process identically with Example except that a rotatable guide roll was used instead of the guide having a gas-jetting device and the respective devices for producing a laminated optical film were installed as shown in FIG. 2.

<Observation of Point Defect>

Samples of laminated optical films were cut from laminated optical films produced in Example and Comparative Example. On a backlight with the brightness of 10,000 cd/m² (manufactured by Raytronics Corp.; trade name, Flat Illuminator), a commercially produced polarizing plate (manufactured by Nitto Denko Corporation; trade name, NPF-SEG1224DU) was placed, and on top of it a sample of a laminated optical film was arranged so that the absorption axes crossed orthogonally, and visual observation was conducted.

A part where a lyotropic liquid crystal compound is uniformly oriented looks black because the absorption axes are orthogonal to each other, but a part where a lyotropic liquid crystal compound is oriented nonuniformly looks bright because the light of the backlight leaks. The bright part corresponds to a point defect.

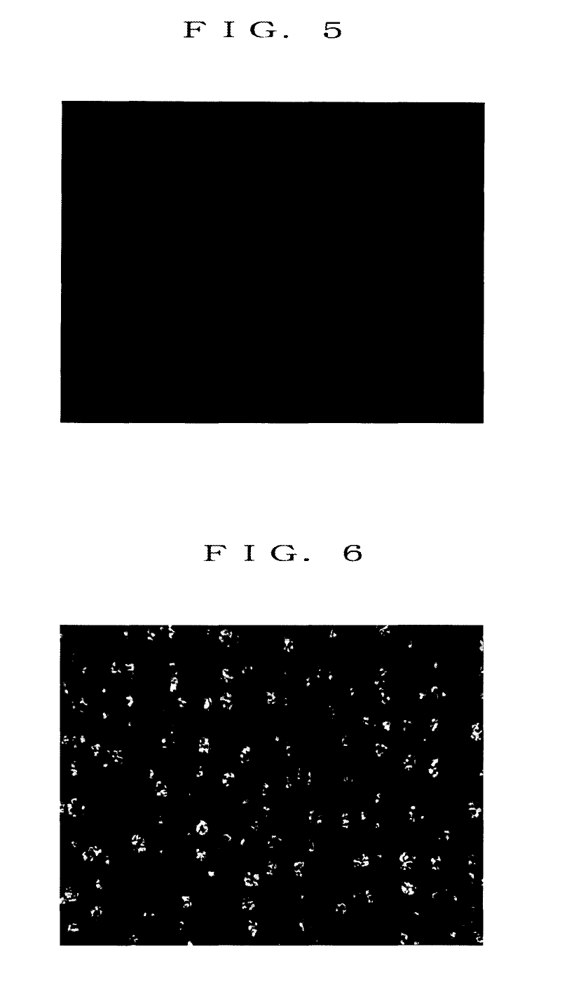

An observation picture of the sample of the laminated optical film according to the Example is shown in FIG. 5; and an observation picture of the sample of the laminated optical film according to the Comparative Example is shown in FIG. 6.

The sample of the laminated optical film according to the Example exhibited absorption dichroism in a visible light range, and a point defect was not observed in it as shown in FIG. 5.

In the sample of the laminated optical film according to the Comparative Example, many point defects were observed as shown in FIG. 6.

### DESCRIPTION OF THE REFERENCE NUMERALS

1: Continuous base film, 2: Rubbing roll, 3: Film on which a rubbing treated surface is formed, 4: Guide having a gas-jetting device, 5: Guide roll, 6: Coater, 7: Drying oven, 8: Optically anisotropic film, 9: Laminated optical film, 11: Gas-jetting holes, 12: Guide surface, 13: Gas feed line, 14: Blower

1. A process for continuously producing a laminated optical film, comprising: a rubbing treatment step of subjecting a surface of a continuous base film to a rubbing treatment to form a rubbing treated surface while the film is transported in a longitudinal direction; a bending transport step of bending and transporting the film subjected to the rubbing treatment step using a plurality of guides for bending the transport direction; and a coating step of coating the rubbing treated surface of the film subjected to the bending transport step with a solution containing a lyotropic liquid crystal compound to form an optically anisotropic film,
wherein in the bending transport step, a guide having a gas-jetting device is used as a guide provided on the rubbing treated surface side to bend the transport direction of the film without contacting the rubbing treated surface with the guide.
